(19) United States
(12) Patent Application Publication
(10) Pub. No.: US 2015/0261013 A1
(43) Pub. Date: Sep. 17, 2015

(54) EYEWEAR DEVICE AND METHOD OF USE

(71) Applicant: DOBBE ENTERPRISE, INC., Niskayuna, NY (US)

(72) Inventors: Owen N. Dobson, Niskayuna, NY (US); Austin S. Dobson, Niskayuna, NY (US)

(73) Assignee: DOBBE ENTERPRISE, INC., Niskayuna, NY (US)

(21) Appl. No.: 14/214,939

(22) Filed: Mar. 15, 2014

(51) Int. Cl. G02C 11/00; G02C 5/00; G02C 11/02; G02C 5/14

(52) U.S. Cl. CPC G02C 11/00; G02C 5/143; G02C 5/008; G02C 11/10; G02C 11/02

(57) ABSTRACT

Embodiments of the disclosure include an eyewear device detachable and removable from a pair of eyeglasses. The eyewear device can be an accessory and a functional device such that any electronics integral with the device are interconnected with wireless and/or satellite communications. The eyewear device may also include a MEMS device for detection of health conditions, atmospheric changes, and hazardous conditions. The MEMS device may also emit a signal for transmission across a network. Further, the eyewear device is utilized for aesthetic reasons, interchangeable fashion-wear, as well as to provide fluorescence or lighting signals when eyeglasses are misplaced. In addition, eyeglasses that fall into water and now have buoyancy at or above the surface where the eyewear device is a floatation device to support the frame.

### FIELD OF THE INVENTION

The present disclosure relates generally to eyewear, and more particularly, to eyewear accessories configured for attachment to eyewear for design and functionality.

### BACKGROUND

Eyewear, prescription glasses and sunglasses included, are common accessories amongst individuals globally. Typically, frames are selected for designer looks, decorative appearance, and ease of use. Sunglasses, as purchased for protection from UV sunrays, also are worn as a fashion statement. For both, it is difficult to accessorize with little variety to the wearer, especially where the wearer has a prescribed set of lenses that are incorporated into a selected frame.

Users of prescription glasses and sunglasses, alike, enjoy the stylish designs of frames but are inconvenienced by the inability to change the appearance, color, or style of frame. Frames also lack the ability to incorporate fashion accessories into the structure of the eyewear. The thick or thin nature of the stem of the eyewear also restricts functionality to properly securing the frames on a person's face.

In addition, eyewear users often misplace or lose eyewear. For instance, when prescription eyewear is moved to sleep, the user may place their eyewear in a remote location away from typical placement at the bedside. A young child may remove eyewear during activity or play and forget where the eyewear was removed. Active persons poolside or fishing from a boat may lean toward the water and lose their eyewear, sunglasses or prescriptive. The weight of the eyewear often causes the frames to sink. Further, the visibility of the eyewear is minimal due to the clear and/or dark contrast of the lenses in combination with stylish frames.

A need exists to improve the stylish nature of eyewear, creating an interchangeable design that affects aesthetic appearance and implements additional functionality. Eyewear users need the ability to easily interchange designs and colors of their eyewear, particularly children who like to accessorize frequently. Eyewear users also need frames that can be quickly located and identified.

It is therefore desirable to have a device that will accommodate personal style while having a functionality that assists in locating and identifying personalized eyewear. Further, the eyewear device and method will assist users in accessorizing to match personal style while facilitating daily retrieval, use and wear. The invention will beneficially address current challenges while expanding eyewear functionality.

### SUMMARY

Embodiments of the invention employ an eyewear device positioned on a sidearm of a pair of eyeglasses. The eyeglasses have two lenses connected by a bridge and set in a frame. The frame includes side arms with comfortable earpieces, the side arms attach to the lens portion of the frame at temples. The eyewear device further has an aperture positioned therethrough such that the eyewear device is stable on the frames.

In one embodiment, an eyewear device comprises: a durable body having an aperture positioned therethrough, the aperture comprising a flexible material with elasticity to slide the durable body over an arm of a pair of eyeglasses and securely position the durable body. The eyewear device can have earpieces removably placed over an end portion of the arms of the pair of eyeglasses. In one aspect, the durable body is comprised of a floatable material having buoyancy to float the pair of eyeglasses.

In another embodiment, the durable body comprises a micro-electromechanical (MEM) device incorporated therein. In one aspect, the eyewear device has electronics components integrated with the eyewear device. The electronics components comprise a radiofrequency identification (RFID) tag, global positions system (GPS) system, microphone, video, webcam, camera, light, LED, wireless chip, antenna communication, bluetooth device, gaming interconnect, smartphone, and mobile device, alone or in combination.

Embodiments of the eyewear device utilize an aperture is integral with the durable body. The aperture may be integrated through a central position or at a peripheral surface where the durable body is three dimensional (3D). Where the durable body is a planar surface or structure, a circular aperture can be affixed to a backside of the two-dimensional (2D) body.

In one embodiment, the flexible material in the aperture is an elastic component. The elastic component, in one aspect, can be activated by temperature. As such, shape memory polymers may be utilized, rubber components, other polymers and plastics. The elastic component is typically removable from the frame, but may also be permanently fixed to the frame by way of an adherent, temperature or chemically active material, or by utilizing a grooved site in the frame of the eyeglasses.

For aesthetic purposes and easily locating eyeglasses, the eyewear device has visual designs, colors and compositions, such as when the durable body has fluorescence. The durable body emits a radiofrequency or audio signal for remote detection also.

Embodiments of the invention incorporate an eyewear assembly comprising: a frame; lenses positioned within the frame and connected at a bridge; a pair of side arms attached to the frame at respective temple portions; an eyewear device having an aperture to slide along at least one of the side arms, wherein the aperture comprises an elastic component that securely positions the eyewear device on the side arm. The aperture may be integral in the eyewear device or configured on a surface of the eyewear device. In one aspect, the elastic component is comprised of a material that expands when activated by temperature.

The eyewear assembly in various embodiments integrates electronic components including interconnection with wireless devices and satellite communications. Identification chips in the eyewear device assist in locating the eyewear assembly remotely. The eyewear device may further comprise a locator chip to remotely locate the eyewear assembly.

Where the eyeglasses are utilized for safety, the eyewear device comprises a micro-electromechanical system (MEMS) to detect atmospheric changes or hazardous conditions and alert a user to the atmospheric change or hazardous condition, respectively.

Embodiments of the eyewear device may be modified and designed as to personal and professional use. Where the devices are modified to any shape, size, and dimension, the aperture is configured so as to securely slide on and off a side arm of the eyeglasses for temporary or permanent placement. A groove integrated at a designated site may also allow more secure positioning. Such modifications and deviations do not depart from the intention and meanings of the invention disclosed herein and are therefore in line with the utility aspects herein disclosed. Without limitation, the eyewear design may be modified in size or shape without departing from the scope of the invention.

### BRIEF DESCRIPTION OF THE DRAWINGS

Features and aspects of embodiments are described below with reference to the accompanying drawings, in which elements are not necessarily depicted to scale.

FIG. 1 depicts a perspective view of an embodiment of the device.

FIG. 2 illustrates an embodiment of the device of the present invention.

FIG. 3 demonstrates the use of a durable body having a longitudinal design.

FIG. 4 depicts a user-interface implemented with a system to implement wireless features.

### DETAILED DESCRIPTION

For the purposes of promoting an understanding of the principles in accordance with the disclosure, reference will now be made to the embodiments illustrated in the drawings and specific language will be used to describe the same. It will nevertheless be understood that no limitation of the scope of the disclosure is thereby intended. Any alternations and further modifications of the inventive features illustrated herein, and any additional applications of principles of the disclosure as illustrated herein, which would normally occur to one skilled in the relevant art and having possession of this disclosure, are to be considered within the scope of the disclosure claimed.

The disclosure is not limited to the particular configurations, process steps, and materials disclosed herein as such configurations, process steps, and materials may vary. The terminology employed herein is used for the purpose of describing particular embodiments and not intended to be limiting.

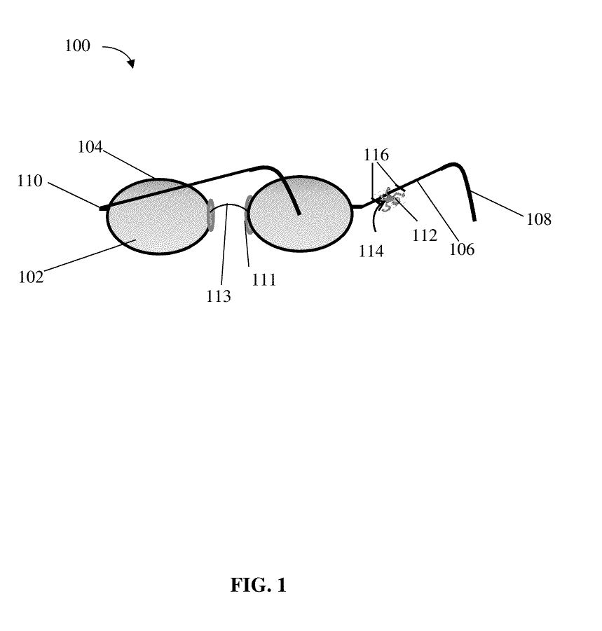

Referring now to FIG. 1, a pair of eyeglasses 100 is illustrated having two lenses 102 connected set in a frame 104 and connected by a bridge 113. The frame includes side arms 106 with comfortable earpieces 108, the side arms attach to the lens portion of the frame at temples 110. Nose pads 111 comfortably position the lenses on the face of a user. An eyewear device 112 is secured to the frame, here, depicted on a sidearm 106 of the eyeglasses. The eyewear device 112 has an aperture 114 positioned through the eyewear device 112 so that the eyewear device is stable on the frames.

In one embodiment, the eyewear device is flexible. In one aspect, this prevents injury to a child during activity. While the aperture 114 is rubberized or flexible enough to slide over the ear piece and side arm, the aperture has an elasticity to secure its position on the side arm. This prevents movement of the eyewear device back and forth on the side arm.

In another embodiment, the eyewear device may be a harder material composition comprised of metallic, ceramic, plastic, or rubber materials, alone or in combination. In an embodiment of the eyewear device being materially hard, the aperture passing therethrough is plasticized/rubberized with elasticity enough to slide the device 112 over the earpiece, along the sidearm, and into a secure position. In this aspect, the aperture has an elastic component positioned therein and integral to the durable body of the eyewear device.

In one embodiment, the frame 104 has a notch or groove 116 that facilitates placement of the eyewear device 112 onto the arm to prevent sliding. The groove 116 may be easily accommodated in a flexible eyeglass frame or rigid frame. Further, the groove may also have a locking mechanism that fixes the eyewear device onto the frame.

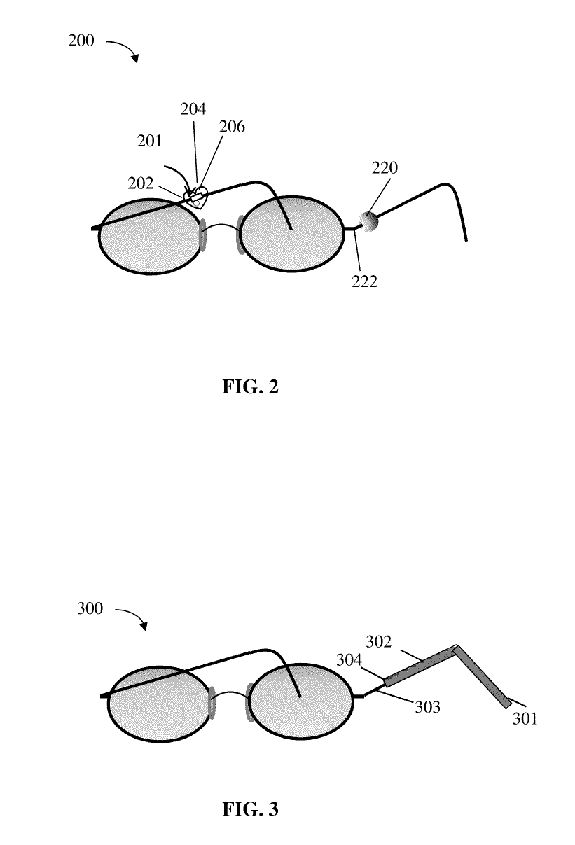

As illustrated in FIG. 1, an eyewear assembly 100 includes an eyewear device 112 that is a toy design. For exemplary purposes, the toy design is a three-dimensional (3D) monkey. In one embodiment, the design is a three-dimensional (3D) configuration having an aperture therethrough such that the aperture has an elastic component. In another embodiment, the design is a two-dimensional (2) configuration with an elastic attachment that secures to the surface of a two-dimensional planar surface, the elastic attachment having an aperture position therethrough. (See FIG. 2.) Any design and configuration may be implemented, however, including sizes ranging from about 1 cm to about 2.5 cm, larger or smaller depending on the size of the eyeglass frame. The eyewear device is as large as desired and small enough so as to prevent interference, injury, annoyance, or intervening sideview vision or distraction. The eyewear device may also provide electronic components to facilitate sideview vision, or vision ranging up to 360°, as when a video-camera is attached on each side arm of the eyeglasses and the data merged into a three-dimensional image. Further, the eyewear device may be a longitudinal length extending anywhere and any length along the side arm, including on the earpiece. As implemented on sunglasses or other eyewear, the elastic attachments can be configured to range in size as well. This permits use over any earpiece or side arm of a pair of eyeglasses.

In one embodiment, the bridge 113 may include an eyewear device securely positioned on the frames, though this may cause a vision distraction. Thus, the eyewear device in this embodiment may be less than 2 mm or smaller so as to fit within the confines and edges of the eyewear frame. Any size and shape configuration of the eyewear device, however, can be employed in the design so as to fit a proportional design of the frames.

In one embodiment, the eyeglasses of the invention have earpieces that are removable so as to allow a smaller aperture in the eyewear device to slide over a narrower portion of the side arm. Once the eyewear device is positioned, the earpieces can be reattached. In another embodiment, the eyewear device is positioned on the earpiece. This allows various configurations and modifications of color, design, size, and shape of eyewear device allowing the person to accessorize and easily modify the eyeglass frames for personalized use. In one aspect, the durable body of the eyewear device is symmetrical, though any configuration may be utilized; as for use on an earpiece, the body may be longitudinally shaped, made of elasticized fabric or spandex materials so as to stretch and securely position the eyewear device onto the side arm of the eyeglasses, provide a waterproofing component for easy and quick drying, as well as provide waterproofing to any integrated electronic components.

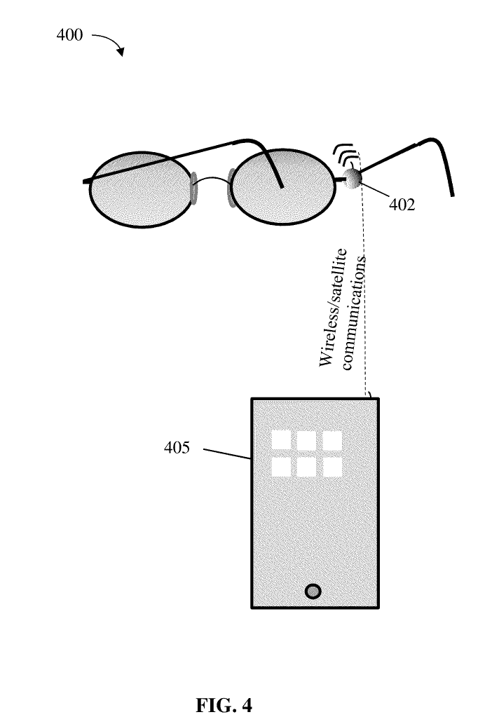

Embodiments of the invention further comprise features to assist the user in locating or finding their eyeglasses. For example, a user that removes his/her glasses to sleep may place the eyeglasses on a stand. As shown in FIG. 2, one embodiment of eyewear 200 is depicted. The eyewear device 202 is shaped as a two-dimensional heart with a backside surface 201 having an elastic aperture 204 affixed thereto. A micro-electromechanical system (MEMS) device 206 is positioned on the device 202 to locate the glasses. A signal can be detected from a remote location, such as a cellular phone, iPhone, computer, tablet, or other mobile device, as pre-programmed into a software program or in a mobile app. The signal can also be used to track the wearer, such as the child. In such instance, the signal may be implemented as a global positioning system (GPS) or radiofrequency (RF) unit for wireless transmission. The eyewear device may also implement a webcam or optical device to record, photograph, capture data as desired, such as video or audio. The optical component may also be part of the MEMS device and include a light-emitting diode (LED) light. The optical component flashes or lights in any color, as desired, for use as a nightlight for a child, as a clap-on or voice activated system, or for flashing automatically, by voice-activation, or in rhythmic patterns as with voice or music. The MEMS device may be used as a locator for finding the glasses or for artistic expression as desired. A sound alert or music may also be integrated in the device 206. In another aspect, the eyeglasses may link to computer peripherals and wearable computer peripherals for remotely accessing and transmitting data, displaying and transmitting data or video. (See FIG. 4.)

Further, the eyewear device is waterproof so as to prevent water damage to the any electrical or optical components of the eyewear device during cleaning, splashing or submerging in water or other liquid. The eyewear device is protected so as to provide an enclosed miniaturized wearable camera and/or video-cam with audio recording capabilities. As such, the eyewear device may capture side-vision perspective views during recording such as during activities and/or sporting events. The side-vision view may also be utilized in security applications or investigation purposes.

Also illustrated in FIG. 2 is a second eyewear device 220, circular in shape and comprises a soft flexible elastic material that stretches and conforms to the frame of the eyeglasses. In one aspect, a floatable eyewear device is position proximate the temple portion 222 of the eyewear 200. The material floats in fresh and salt water as would a fishing bobber. For exemplary purposes, and not limitation, a user who is swimming or fishing and loses his/her eyeglasses in the water can easily retrieve the eyeglasses by searching for the eyewear device 220 floating at the water surface. In one aspect, colorful designs of the floatable eyewear device would permit easier retrieval. In another aspect, an optical or auditory component would allow automatic or remote voice-activated signaling as triggered by a command.

As shown in FIG. 3, eyewear 300 is depicted. The eyewear accessory 302 is a longitudinal length extending from a distal end 301 of the earpiece 303 to a proximal end 304. The length, however, may extend anywhere and any length along the side arm, including the length of the earpiece. The eyewear accessory 302 comprises a hollow aperture therethrough that is closed at the distal end 301, as illustrated, and slides over the surface of the side arms 303 of the frame 305. An open end at the distal end would allow a longitudinal accessory to be positioned anywhere along the length of the side arm. The longitudinal eyewear accessory extends a length as desired or determined by the length of a sidearm. In one aspect, the longitudinal eyewear accessory has an aperture with flexibility enough to slide over the earpiece 307 and with elasticity enough to be secured onto the earpiece without sliding. Preferably, the material of the eyewear accessory is comfortable and/or soft for positioning near or adjacent the wearer's skin or ear. The eyewear accessory is a floatable material, with buoyancy to float the eyewear (and its lenses) at the surface of water for easy discovery and identification.

In another aspect, the durable body is a longitudinal body that is employed as earpiece designs to provide buoyancy to the frame when dropped in fresh or salt water. The longitudinal body may also be interchanged for fashionable wear to accessorize an outfit, so as to include a variety of color selections, size, shape, and dimensions as desired. Further, the length of the longitudinal body, or various configurations of the durable body, provide a greater surface area to integrate features such as electronics, identification tags, antennae for radiofrequency or satellite communications, music playback or recording, as well as audio or video capture and record. The interchangeable nature of the durable body allows personal selection and accessorizing. For exemplary purposes, and not limitation, a child may utilize the eyepiece designs as collectables or for sharing with friends. In one embodiment, the eyepieces are game-pieces that correspond to points and game-play scenarios.

Embodiments of the invention may be personalized for identification and retrieval, or as desired. Such features may include optical components such as LED's, or audible recordings that may be easily recorded, erased, and re-recorded or programmed. Such features allow aesthetic attributes to be implemented on the standardized eyewear, including both prescriptive and designer wear such as sunglasses.

As illustrated in FIG. 4, a pair of eyeglasses 400 is remotely accessible via a mobile device 405. The mobile device has an application to connect with the eyewear device 402 by way of wireless communications using bluetooth or other radiofrequency, as well as satellite communications.

Furthermore, the eyewear devices may be comprised of polymeric materials, such as shape memorial materials that expand when activated by temperature. Material compositions that are utilized may also be shaped and molded, as designed by a user, and secured by temperature or chemical activation without damaging the frames or side arms of the eyeglasses.

As stated prior, embodiments taught herein may be used in a variety of styles and utilizing an assortment of features to assist a user in identifying, personalizing, locating and retrieving eyewear. The device may be useful in many different types of settings, but seemingly apparent in the growing culture of today's youth, elderly, and those active in sports or water activities. Other systems may be integrated in industrial production settings, particularly in sterile settings, machining or manufacturing, as during personalized inspection and/or review. Vision-based object verification algorithms can also be utilized and implemented to assist in such processes.

Having thus described several exemplary embodiments of the invention, it is to be appreciated various alterations, modifications, and improvements will readily occur to those skilled in the art. For example, in some embodiments, such alterations, modifications, and improvements are intended to be part of this disclosure, and are intended to be within the scope of the invention. Accordingly, the foregoing description and drawings are by way of example only.

What is claimed is:

1. An eyewear device comprising: a durable body having an aperture positioned therethrough, said aperture comprising a flexible material with elasticity to slide the durable body over an arm of a pair of eyeglasses and securely position the durable body.

2. The eyewear device of claim 1, wherein the durable body is interchangeable with a second durable body.

3. The eyewear device of claim 1, further comprising earpieces removably placed over an end portion of the arms of the pair of eyeglasses.

4. The eyewear device of claim 3, wherein the durable body is a longitudinal earpiece having a proximal end with the aperture positioned therethrough to a closed distal end.

5. The eyewear device of claim 1, wherein the durable body is comprised of a floatable material having buoyancy to float the pair of eyeglasses.

6. The eyewear device of claim 1, wherein the durable body comprises a micro-electromechanical (MEM) device incorporated therein.

7. The eyewear device of claim 1, further comprising electronics components integrated with the eyewear device.

8. The eyewear device of claim 7, wherein the electronics components comprise a radiofrequency identification (RFID) tag, global positions system (GPS) system, microphone, video, webcam, camera, optical component, LED, wireless chip, antenna communication, bluetooth device, gaming interconnect, smartphone, and mobile device, alone or in combination.

9. The eyewear device of claim 1, wherein the flexible material in the aperture is an elastic component.

10. The eyewear device of claim 9, wherein the elastic component is activated by temperature.

11. The eyewear device of claim 9, wherein the elastic component is capable of permanently placement on the frame by way of an adherent or notched groove in the frame.

12. The eyewear device of claim 1, wherein the durable body has fluorescence.

13. The eyewear device of claim 1, wherein the durable body emits a radiofrequency or audio signal for remote detection.

14. An eyewear assembly comprising:
a frame;
lenses positioned within the frame and connected at a bridge;
a pair of side arms attached to the frame at respective temple portions;
an eyewear device having an aperture to slide along at least a portion of one of the side arms, wherein the aperture comprises an elastic component that securely positions the eyewear device on the side arm.

15. The eyewear assembly of claim 14, wherein the elastic component is comprised of a material that is malleable is securely positioned when activated by temperature or chemicals.

16. The eyewear assembly of claim 14, wherein the eyewear device comprises electronics components including interconnection with wireless devices and satellite communications.

17. The eyewear assembly of claim 14, wherein the eyewear device comprises an identification chip to locate the eyewear assembly remotely.

18. The eyewear assembly of claim 14, wherein the eyewear device comprises buoyant material components to float the eyewear assembly at or above a liquid surface.

19. The eyewear assembly of claim 16, wherein the eyewear device is utilized in surveillance, GPS positioning, identification, industrial inspection, and investigation, individually or in combination, further comprising computer-based algorithms to correlate data.

20. The eyewear assembly of claim 17, wherein the eyewear device comprises a micro-electromechanical system (MEMS) to detect atmospheric changes or hazardous conditions, and provides an alert to a user as to the atmospheric change or hazardous condition, respectively.
